(19) United States
(12) Patent Application Publication
(10) Pub. No.: US 2014/0374553 A1
(43) Pub. Date: Dec. 25, 2014

(54) ATTACHABLE PAD FOR A SUPPORTER

(71) Applicant: Min Sik PARK, Seoul (KR)

(72) Inventor: Min Sik PARK, Seoul (KR)

(21) Appl. No.: 14/465,973

(22) Filed: Aug. 22, 2014

Related U.S. Application Data
(63) Continuation-in-part of application No. 13/522,086, filed on Jul. 13, 2012.

(30) Foreign Application Priority Data
Oct. 28, 2010 (KR) 10-2010-0105811

(51) Int. Cl. F16B 47/00; A47G 1/17

(52) U.S. Cl. CPC F16B 47/00; A47G 1/17
USPC 248/205.5

(57) ABSTRACT

An attachable pad for a support includes an attachable pad body, an attachment sheet bonded to the attachable pad body, a cap covering the attachable pad body, an operation cap fixing the cap to the attachable pad body, and a support-connecting fixing ring between the cap and the operation cap. A main body wing is integrally provided in the attachable pad body between the attachment sheet and the attachable pad body. A fixing screw nut is integrally molded to the attachable pad body. A fixing screw bolt is separated from the nut to fix the fixing screw bolt to the fixing screw nut. A second pressing member is provided inside the cap to support the body wing. The second pressing member presses the body wing together with the body to the surface of an object while a first pressing member is pressing the body to the surface of the object.

### CROSS REFERENCE TO RELATED APPLICATIONS

This is a continuation-in-part application of U.S. patent application Ser. No. 13/522,086, filed on Jul. 13, 2012, which is a national entry of International Application No. PCT/KR2010/007496, filed on Oct. 29, 2010, which claims a priority to and the benefit of Korean Patent Application No. 10-2010-0105811, filed on Oct. 28, 2010, the contents of which in their entirety are herein incorporated by reference.

### TECHNICAL FIELD

The present invention relates to an attachable pad, and more particularly, to an attachable pad that can overcome the drawbacks of an attachable pad of the related art, namely, that the supportable load is tightly limited when vacuum compression is used or that the sealing attachment is disabled as time passes or vacuum pressure is released when the attachable pad is based on a sealing attachment. The attachable pad can maintain the bonding of the sealing attachment as time passes, and thus semi-permanently maintain the attached state as if it were in a fixed state obtained by a physical means such as by fixing by a nail. In addition, the attachable pad can be easily detached as required.

### BACKGROUND ART

As shown in FIG. 1A and FIG. 1B, a vacuum absorber, which is so-called a first-generation vacuum compression pad, includes a body 120, which has a hollow section and a through-hole in the central portion thereof, a suction plate 143, which is seated in a front opening of the body 120, a bolt 141 fixed to the suction plate 143, and a rotary member 150, which is fastened to the bolt 141, which extends through a through-hole 151. The suction plate 143 is made of a soft rubber, and is attached by vacuum pressure that is generated in response to upward movement of the suction plate 143.

In the vacuum absorber 100 according to the related art as described above, the suction plate 143 must be made of a flexible and soft material. Therefore, the following problems occur: the weight that the vacuum absorber 100 can support is limited, the vacuum absorber 100 is dislodged when the load exceeds the limit, and the suction plate 143 is twisted and is easily detached when the load applied to the vacuum absorber 100 is directed perpendicular to the bolt 141.

In order to overcome the drawbacks of the first-generation vacuum compression pad, Korean Laid-Open Patent Publication No. 10-2006-0121626 is configured such that a packing 230 is seated on the outer circumference of the front opening of a body 220, and that a bolt 241 of a suction plate 243 extends through a through-hole, as shown in FIGS. 2A and 2B. In the state in which the bolt 241, which extends through the through-hole, is fastened with a rotary member 250, the bolt 241 rotates the rotary member 250 while tightly attaching the packing 230 to a tile or a wall surface. When the rotary member 250, inside of which the nut 251 is seated, rotates, the fastened bolt 241 presses the packing 230 using the suction plate 243 while being moved upwards. When the packing 230, which is supported by a fixing ring 225 of the body 220, is pressed, its shape is deformed by a buffer groove 231 and a portion that composes a sealing attachment portion 233 protrudes forward, thereby blocking the movement of air. A space that is sealed hermetically is expanded by the suction plate 243 that is moving, thereby generating vacuum pressure. Therefore, a vacuum absorber 200 is fixed to a tile or a glass surface owing to the difference between the vacuum pressure that is created inside the absorber 200 and the ambient atmospheric pressure.

However, in the absorber using the difference between the vacuum pressure, which is created inside the absorber, and the ambient atmospheric pressure, there are drawbacks, namely, that the weight that the absorber can support is limited due to the difference between the pressures, and that the attached state is easily disabled when a predetermined weight is exceeded.

In order to overcome the drawback that the weight that the related art using the absorber as described above can support is limited, Korean Patent Publication No. 10-2008-0102500 introduces a new technology, namely a sealing attachment, as another related art of the invention. This technology was patented Sep. 21, 2009 and was assigned to the applicant of the invention on Dec. 3, 2009. As shown in FIG. 3A and FIG. 3B, this related art provides an attachable pad that includes a body 310, which has a screw portion, a sheet-shaped attachable portion 320, which extends outward from one end of the body, and a cap 340, which is provided in a screw portion 317 of the body such that it can screw. The cap 340 presses the attachable portion 320 against a surface 330 on which the attachable pad is to be attached. An operation cap 341 is provided in the upper portion of the cap such as to screw into the screw portion 317 of the body, and an annular packing 345 is provided in the cross-section of the cap 340 that is attached to the attachable portion 320. The attachable portion 320 has a plurality of pieces of annular packing 325 on the surface 330 thereof, the pieces of packing being spaced apart from each other in a radial direction. The attachable portion 320 has a pointed portion 321 on one edge thereof.

When the attachable portion 320 described above is attached to the surface 330 by pressing on it, the attachable portion 320 is more tightly attached to the surface 330 by vacuum pressure that is created between the attachable portion 320 and the surface 330, and/or the adhesive force of the attachable portion 320. Therefore, the weight that the absorber of the related art using the vacuum pressure can support is 5 kg, whereas the weight that the technology using the attachable portion 320 can support is 20 kg.

However, in the technology that uses the attachable portion 320, as is clearly shown in the cross-section of FIG. 3B, the annular packing 345 and a plurality of pieces of plastic packing 325 must be provided between the attachable portion 320 and the circumference of the cap 340 and between the attachable portion 320 and the surface 330 in order to prevent water, moisture or the like from penetrating between the attachable portion 320 and the surface 330. Here, the annular packing 345 and the plastic packing 325 are fixed along the circumference of the cap 340, between the cap and the attachable portion and between the attachable portion and the surface 330. Tightening the cap 340 in this fashion also pulls on the body 310 that is integrated with the screw portion 317. Accordingly, as time passes, the adhesive force of the attached surface of the body with respect to the surface 330 decreases, such that the attachable pad is consequently detached.

To describe once more the problem that the strong attaching force of the related art decreases, the operation cap 341 in the upper portion of the cap 340 is provided such that it can screw with the screw portion 317 that is integrated to the body 310. Owing to the operation cap 341, the cap 340 can more strongly press the attachable portion 320 on the portion where the cap 340 is attached to the attachable portion 320 along the circumference of the cap. In this process, the operation cap 341 presses against the cap 340 using the force with which the body 310 is attached to the surface, i.e. an opposing force to the adhesive force of the body. As a result, this presses on the annular packing 345, which is positioned at the portion that is in contact with the attachable portion on the circumference of the cap 340, and the plurality of pieces of plastic packing 325, which are spaced apart from each other in a radial direction. Here, the force pressing upon the cap 340 counteracts the adhesive force of the body, thereby acting to pull the body 310 from the surface on which the body 310 is attached. As time passes, the attaching force of the body 310 with respect to the surface 330 weakens, so that the body 310 is detached from the surface 330.

The present invention has been made keeping in mind the above problems occurring in the related art, and is intended to provide an attachable pad, which can overcome the drawbacks of the attachable pad of the related art that use vacuum compression, namely, that the sealing attachment is disabled as time passes or the vacuum pressure is released. Instead, the attachable pad can complete the bonding of the sealing attachment as time passes and thus semi-permanently maintain the attached state as if it were in a fixed state obtained by a physical means such as by fixing by a nail. In addition, the attachable pad can be easily detached as required.

### DISCLOSURE

### Technical Problem

Although the attachable pad of the related art described above has the merit of overcoming the problem that the weight that can be supported is limited when it depends on the absorber unit of the related art, there are other problems in that the attachable pad cannot be attached for a long time, for example, 1 or 2 years. Consequently, in some cases, an object that is supported by the attachable pad may drop to the ground, thereby damaging itself or, what is worse, damaging other articles or people below the object. Therefore, it was necessary to invent an attachable pad that can support a weight of 20 kg or more while semi-permanently maintaining it in a secure state of attachment.

Another problem with the attachable pad of the related art described above is that the body is thicker than the attachment sheet and thus the melting temperature of the body becomes different from that of the attachment sheet when attaching the attachment sheet to the portion of the body that is intended to be attached on the surface of the object in the manufacturing process thereof. Therefore it is not easy to attach the attachment sheet to the body. Most importantly, in the attachable pad of the related art, an annular packing and a plurality of pieces of plastic packing, which are spaced apart in a radial direction, are prepared along the circumference of the body in order to assist the attachment of the attachment sheet. The pieces of packing are pressed on by the cap in the portion of the circumference of the cap in which the cap is in contact with the attachment sheet, thereby preventing water, moisture and the like from entering. However, such an auxiliary unit makes the configuration of the attachable pad complicated, thereby creating some undesirable problems in the manufacture and maintenance of the attachable pad. It is therefore necessary to make an invention that facilitates the manufacture of the attachable pad and reduces the cost of manufacture by simplifying the configuration of the attachable pad.

### Technical Solution

In one aspect, the present invention provides an attachable pad for a support in which an object can be supported by sealing attachment of an attachment pad. The attachable pad includes: an attachable pad body having a fixing crew bolt; an attachment sheet bonded to the attachable pad body; a cap covering the attachable pad body, the cap having a through-hole through which the fixing screw bolt passes; an operation cap fixing the cap to the attachable pad body; a body wing formed integrally on the attachable pad body, the diameter of the body wing being greater than the diameter of the attachable pad body, the thickness of the body wing being smaller than the thickness of the attachable pad body; a first pressing member formed inside the cap around the through-hole of the cap; and a second pressing member formed inside the cap at a portion that corresponds to the body wing. When the operation cap brings the cap into tight contact with the body, the first pressing member presses the attachable pad body against a surface of the object on which the attachable pad is to be attached, and the second pressing member presses the body wing against the surface of the object.

### Advantageous Effects

As described above, the configuration including the body wing 480 and the second pressing member 490 realizes significant effects that enable a load of 20 kg or more, which cannot be realized in the related art, to be semi-permanently attached using a unique adhesive force, which is referred to as the sealing attachment of the attachment sheet 420. In particular, in the sealing attachment configuration of the invention, the annular packing is provided in the attachment sheet contact portion on the circumference of the cap, which required essential components in the related art, and the auxiliary attachment configuration that provides a plurality of pieces of plastic packing between the attachment sheet and the surface of the object on which the attachable pad is to be attached is omitted.

In the invention, after the attachment sheet is tightly attached on the surface, the body wing is pressed upon by the second pressing member. Consequently, the body wing portion of the attachment sheet is also tightly attached to the surface of the object, thereby preventing vacuum pressure from occurring. This, as a result, semi-permanently maintains the adhesive force that is unique to the attachment sheet.

In the attachable pad of the invention, after the attachment sheet is tightly attached on the surface of the object by hand or the like so that air is not introduced into the attachment sheet 420, air intake is blocked by fastening the body 410 and the body wing 480 to each other using the first pressing member 510, which is provided inside the cap, and the second pressing member 490. They do not detach from each other at temperatures ranging from 25° C. below zero to 85° C. above zero, and semi-permanent sealing attachment is possible.

### DESCRIPTION OF DRAWINGS

FIG. 1A and FIG. 1B are views schematically showing an absorber of the related art;

FIG. 2A and FIG. 2B are views schematically showing an improved vacuum absorber of the related art;

FIG. 3A is an exploded perspective view of an attachable pad of the related art;

FIG. 3B is a cross-sectional view schematically showing the state in which the attachable pad in the exploded perspective view of FIG. 3A is assembled and the annular packing is enlarged;

FIG. 4A is an exploded perspective view of an attachable pad according to an embodiment of the invention;

FIG. 4B is an explanatory view showing the state in which a fixing screw nut and a fixing screw bolt in the view of FIG. 4A are detached;

FIG. 5A is a view showing the state in which an attachable pad in the exploded perspective view of FIGS. 4A and 4B is assembled and attached to an object wall;

FIG. 5B is a cross-sectional view taken along line A-A of the view of FIG. 5A;

FIG. 6 is an exploded perspective view of an attachable pad according to another embodiment of the invention;

FIG. 7A is a view showing the state in which an attachable pad in the exploded perspective view of FIG. 6 is assembled and attached to an object wall; and

FIG. 7B is a cross-sectional view taken along line B-B in FIG. 7A.

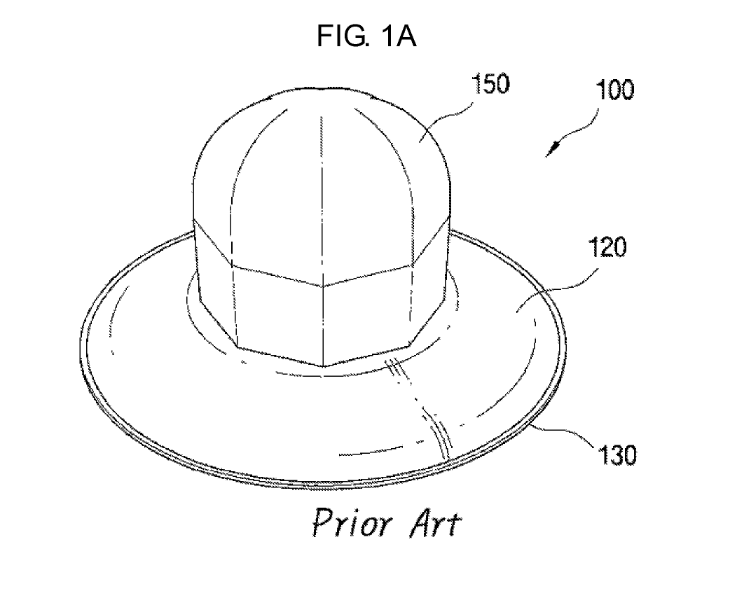

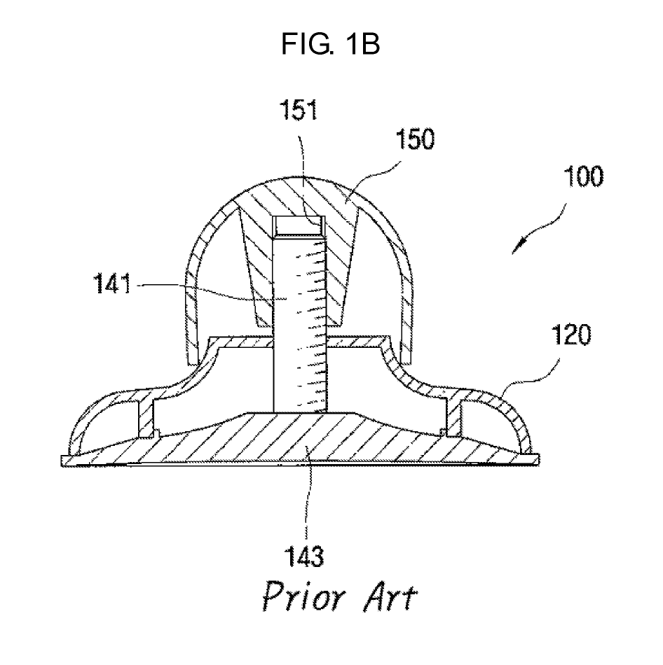

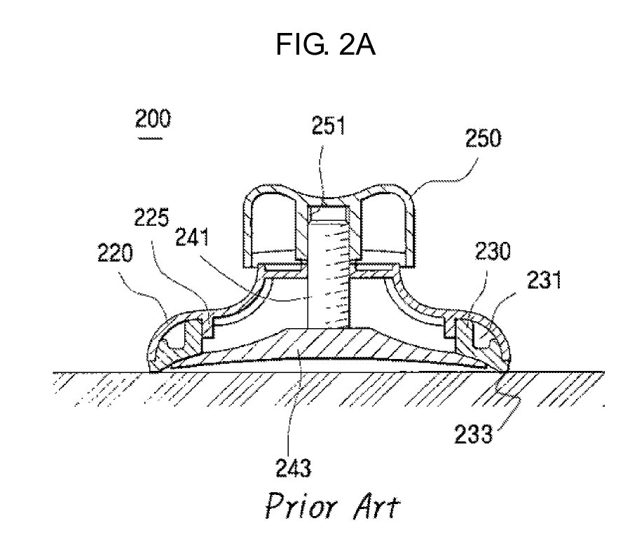

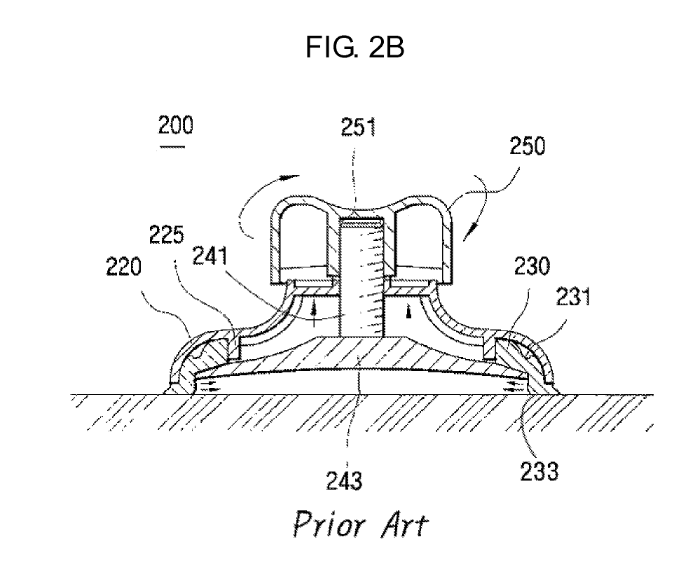

### MAJOR REFERENCE NUMERALS OF THE DRAWINGS

410: attachable pad body,
420: attachment sheet,
421: detachable tab,
430: fixing screw bolt,
440: fixing screw nut,
450: cap,
460: operation cap,
470: support-connecting fixing ring,
480: body wing,
490: second pressing member,
500: through-hole,
510: first pressing member,
520: support-connecting fixing member

### MODE FOR INVENTION

Hereinafter, the present invention will be described in detail with reference to the accompanying drawings.

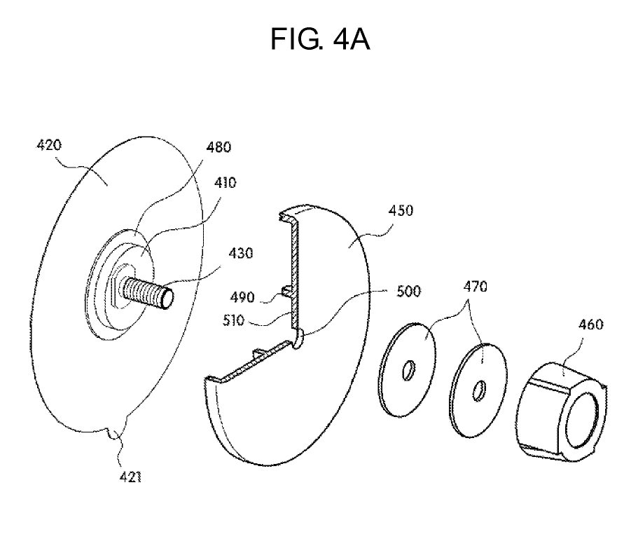

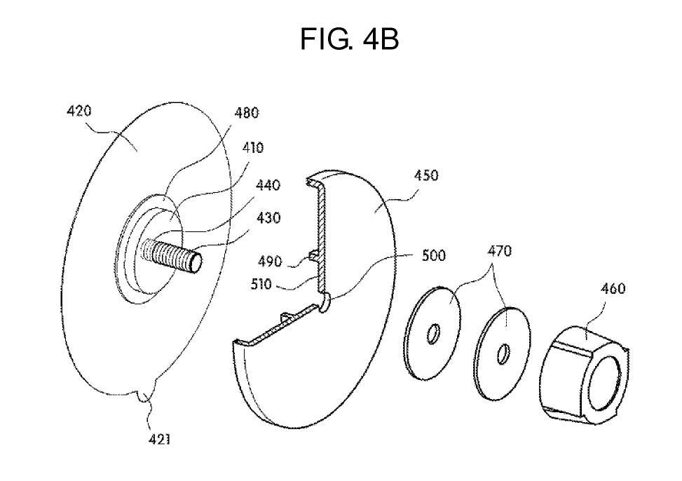

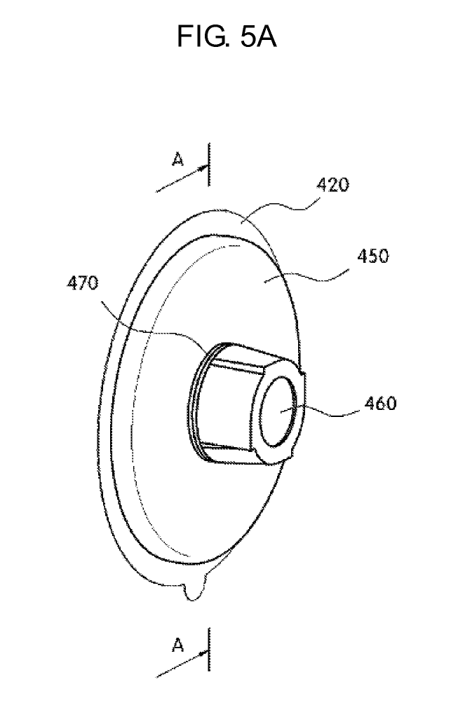

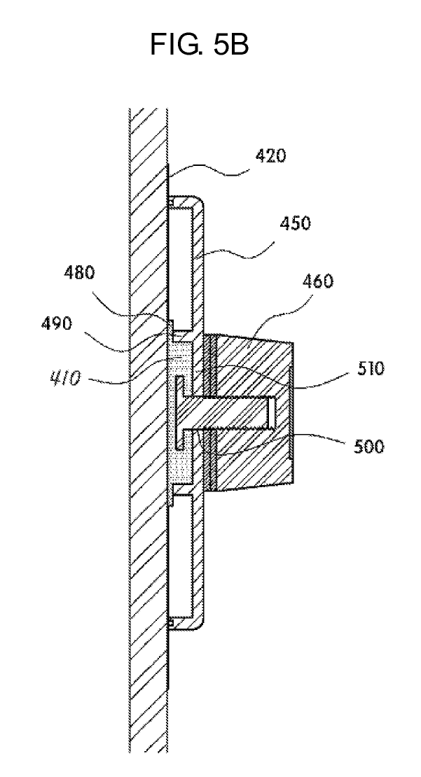

FIG. 4A is an exploded perspective view of an attachable pad according to an embodiment of the invention, and FIG. 4B is an explanatory view showing the state in which a fixing screw nut 440 and a fixing screw bolt 430 in the view of FIG. 4A are detached. In addition, FIG. 5A is a view showing the state in which the attachable pad in the exploded perspective view of FIG. 4 is assembled and attached to an object wall.

As shown in FIG. 4A, the basic configuration of the attachable pad of the invention includes an attachable pad body 410; an attachment sheet 420; the fixing screw bolt 430, which can be integrally formed with the body (e.g. by molding), or the fixing screw bolt 430, the length and size of which can be determined depending on the size and weight of an article which is to be supported on the fixing screw nut 440 via the attachable pad, and to the surface of which the attachable pad is to be attached, while the fixing screw nut 440 is integrally formed with the body (e.g. by molding); a cap 450, which is fixed to the fixing screw bolt 430 to cover the attachable pad body 410; and an operation cap 460, which is screwed with the fixing screw bolt 430, thereby fixing the cap 450 to the body 410 via the fixing screw bolt 430.

A support-connecting fixing ring 470 is a part of a support connecting device that is fixed to the fixing screw bolt 430 between the cap 450 and the operation cap 460 such that the article can be supported. In addition, a detachable tab 421 is a knob with which the attachable pad, which is firmly attached, can be attached to and detached from the wall surface.

Returning to FIG. 4A, a body wing 480 is formed integrally on the attachable pad body 410. The body wing 480 is made of the same material as the body. The diameter of the body wing 480 is greater than the diameter of the attachable pad body 410, and the thickness of the body wing 480 is smaller than the thickness of the attachable pad body 410. The diameter of the body wing 480 ranges from 1.2 to 2 times the diameter of the body in order to prevent the size of the attachment sheet 420 from being excessively increased. The thickness of the body wing 480 ranges from approximately 0.3 mm to 1 mm in order to allow easy high-frequency thermal fusion between the thin attachment sheet 420 and the body wing 480.

The body wing 480 is molded from the same material as the body, which is made of a synthetic resin, and the attachment sheet 420 is attached to the body wing by high-frequency thermal bonding, so that the attachment sheet 420 is tightly attached to the surface of the article on which the attachable pad is to be attached. Even though the body wing 480 of the invention is much thinner than the body, when the fixing screw bolt 430 is supported in the state of being fixed to the body 410 in cooperation with a second pressing member 490 inside the cap 450, which will be described later, it is possible to provide a standing function to support the weight of the fixing screw bolt together with the supported article using counter movement in the body wing portion of the lower end of the circumference of the body. Therefore, it is possible to overcome the problem of the related art that the attachment sheet is deformed starting at the upper portion in the circumference of the body owing to the absence of the body wing portion.

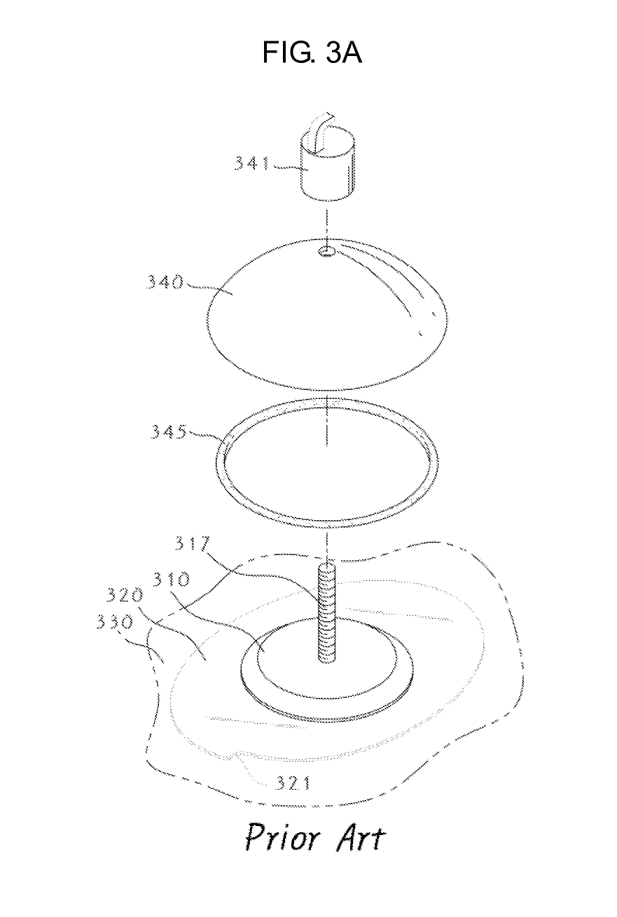

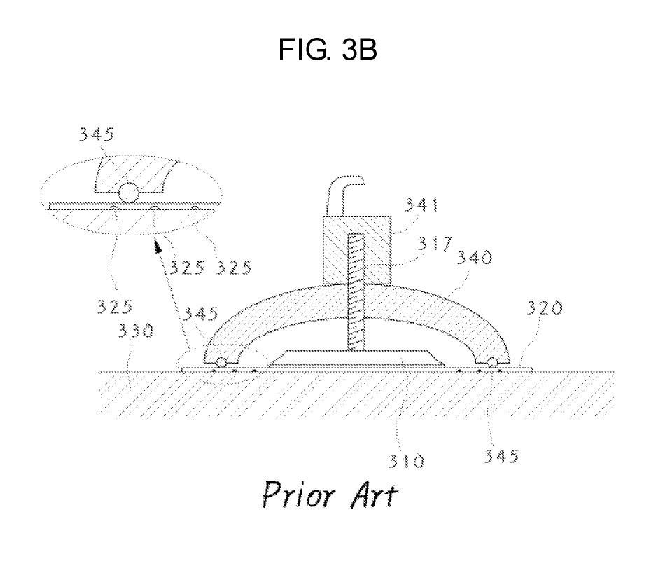

In the related art, i.e. in Korean Laid-Open Patent Publication No. 10-2008-0102500 referring to FIG. 3A and FIG. 3B, the body 310 (corresponding to the attachment pad body of the present invention) is coupled with the attachable portion 320 (corresponding to the attachment sheet of the present invention) without a body wing portion unlike in the present invention. In addition, in a structure in which the upper portion of the body 310 and the cap 340 define a space therebetween and the cap 340 and the attachable portion 320 are in tight contact on the circumferential pillar of the cap 340, a force with which the body 310 presses the attachable portion 320 is smaller than a force with which the attachable portion 320 is pressed on the circumferential pillar of the cap 340 due to the weight that is continuously applied by the screw portion 317. Consequently, the attachable portion 320 in contact with the body 310 is detached and raised upwards from the surface 330, thereby loosening the sealing attachment to the surface 330. Consequently, the attachable pad detaches from the surface 330.

In the present invention, the protruding second pressing member 490 is formed inside the cap 450. The second pressing member 490 serves to support and press the body wing 480.

The inner structure of the cap 460 is configured such that the second pressing member 490 presses the body wing 480 against the surface of the article while the first pressing member 510 is pressing the body 410 against the surface when the second pressing member 490 applies force to the cap 450 using the operation cap 450 so that the cap 450 is tightly attached to the body 410. The heights by which the first pressing member 510 and the wing support 490 protrude are properly adjusted for that purpose. The first pressing member 510 inside the cap is positioned around the through-hole 500 inside the cap through which the fixing screw bolt 430 in the central portion of the cap 450 passes. With the second pressing member 490 constructed as described above, after the attachment sheet 420 is tightly attached to the surface of the article from the outer portion in the circumference of the body wing 480, the cap 450 is fastened to the attachable pad body 410 using the operation cap 460, so that the attachment sheet stays in the tightly attached state in the portion of the body wing 480. Indeed, the complete tightly attached state is formed over the entire attachment surface of the attachment sheet, owing to the attaching force between the surface of the article and the attachment sheet 420.

Therefore, the invention does not face the problem of the related art that, since the force that presses on the cap 340 originates from the attaching force of the body, the attaching force of the body with respect to the surface of the article decreases as time passes, and consequently the body is detached from the surface 330. Even when a considerable load is applied for a long time to the fixing screw bolt 430 via the support-connecting fixing ring 470, owing to the action of the body wing 480 and the second pressing member 490 in the portion of the first pressing member 510 of the attachable pad body that is attached to the attachment sheet, the attachment sheet 470 is tightly attached to the surface of the article, so that the attachable pad of the invention stays in a semi-permanently attached state.

In addition, the attachment sheet 420 is a soft thin plate made of a material having superior adhesive force such as PVC or urethane (Especially, Temperature polyurethane (TPU)). It is preferable that the thickness of the attachment sheet 420 ranges from 0.15 to 0.3 mm. A user attaches the attachment sheet 420 to the surface of an article on which the attachable pad is to be attached by rubbing the attachment sheet 420 against the surface of the article by hand such that air does not remain between the attachment sheet 420 and the surface of the article. The article is preferably glass or tile since the attachment sheet 420 must be attached to the surface of the article using the unique adhesive force of the attachment sheet 420.

With the configuration described above, the invention maintains the tightly attached state between the surface of the article and the attachment sheet. The tightly attached state that remains in this fashion prevents vacuum pressure from occurring inside the attachment surface and has the effect of expelling minute pockets of gas that remain between the surface of the article and the attachment sheet. Since vacuum pressure does not occur inside the attachment surface in this fashion, the surface of the article and the attachment sheet are integrated. It is possible to essentially block water or moisture from entering from outside the attachment surface.

A brief description will be given of a method of using the above-described attachable pad according to the present. First, the attachment sheet 420 in the shape of a thin film is attached to the surface of an article, such as glass or tile, by rubbing the attachment sheet. The user attaches the attachment sheet 420 to the surface of the article in a sealing fashion by rubbing the surface of the attachment sheet 420 in the direction from the center to the periphery by hand or the like such that minute air voids are not formed between the attachment sheet 420 and the surface of the article.

Here, the attachment sheet 420 has the attachable pad body 410 and the body wing 480 affixed thereto by thermal fusion. The body wing 480 integrally expands from the attachable pad body 410, and the thickness of the body wing 480 is smaller than the thickness of the attachable pad body 410. The attachable pad body 410 is provided with the fixing screw bolt 430.

After the attachment sheet 420 is attached to the surface of the article in a sealing fashion, the user covers the attachment sheet 420 with the cap 450 while fitting the fixing screw bolt 430 into the through-hole 500. The user preferably increases the adhesive force of the attachment sheet 420 to the surface of the article by rotating the cap 450 clockwise or counterclockwise several times in the state in which the inside of the cap 450 is pressed, i.e. the first pressing member 510 presses the attachable pad body 410 and the second pressing member 490 presses the body wing 480.

In addition, a circumferential edge formed on the periphery of the cap 450 protrudes into the cap, and comes into tight contact with the periphery of the attachment sheet 420.

Finally, the cap 450 is fixed to the attachable pad body 410 by fastening the operation cap 460 with the fixing screw bolt 430.

In this specification, vacuum pressure refers to negative (−) pressure, which is generated between the surface of the article and the attachment sheet, and can act to take in moisture or the like from the outside.

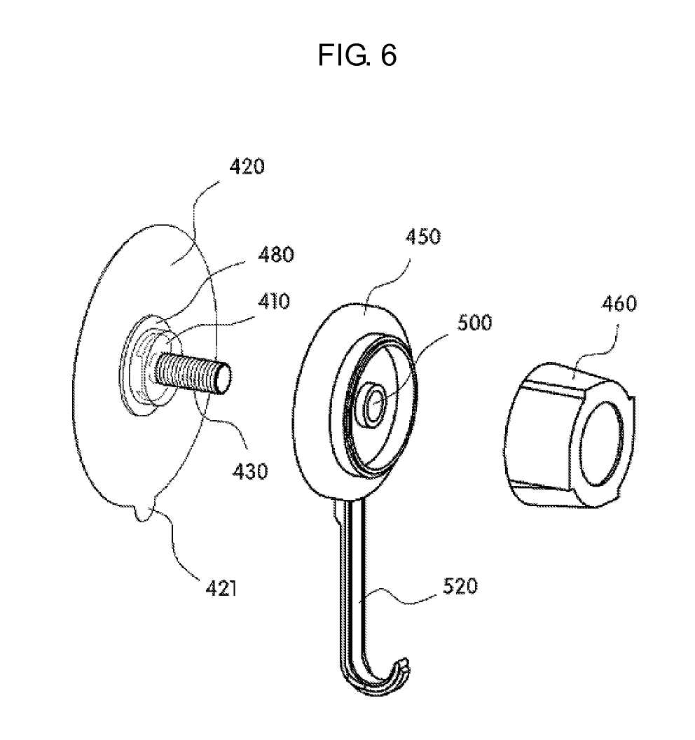

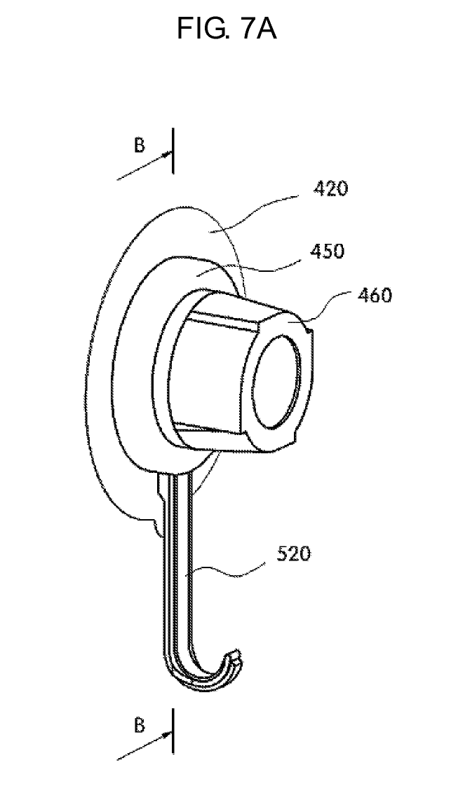

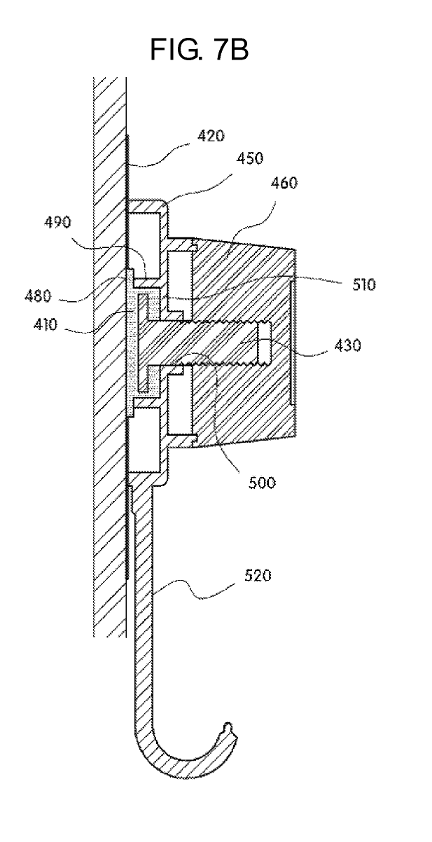

FIG. 6 is an exploded perspective view of an attachable pad according to another embodiment of the invention, FIG. 7A is a view showing the state in which an attachable pad in the exploded perspective view of FIG. 6 is assembled and attached to an object wall, and FIG. 7B is a cross-sectional view taken along line B-B in FIG. 7A.

As shown in FIG. 6, the attachable pad of the invention includes the attachable pad body 410; the attachment sheet 420; the fixing screw bolt 430, which can be integrally molded with the body, or the fixing screw bolt 430, the length and size of which can be determined depending on the size and weight of the article that is to be supported on the fixing screw nut 440 via the attachable pad, while the fixing screw nut 440 is integrally molded to the body; the cap 450, which is fixed to the fixing screw bolt 430 to cover the attachable pad body 410; and the operation cap 460, which is screwed with the fixing screw bolt 430, thereby fixing the cap 450 to the body 410 via the fixing screw bolt 430.

In the embodiment of the invention shown in FIG. 6, unlike the embodiment shown in FIG. 4A, a support-connecting fixing member 520 is integrally molded with the cap 450 without a separate support-connecting fixing ring. With this configuration, the cap 450 is fixed to the body 410 using the operation cap 460, so that the assembly of the attachable pad is complete.

What is claimed are:

1. An attachable pad for a support comprising:
an attachable pad body having a first diameter and a first thickness, the attachable pad having a fixing screw bolt;
a body wing having a second diameter greater than the first diameter and having a second thickness smaller than the first thickness, the body wing being integrally formed with the attachable pad body;
an attachment sheet bonded to the body wing and having a third diameter greater than the second diameter, the attachment sheet being soft and thin sheet made of a material having adhesive force, the attachment sheet contacting a surface on which the attachable pad is to be attached;
a cap covering the attachable pad body and the body wing, the cap having a through-hole through which the fixing screw bolt passes and protrudes outside the cap, wherein the circumferential edge of the cap contacting the attachment sheet; and
an operation cap screw-engaged with the fixing screw bolt;
a first pressing member formed inside the cap around the through-hole of the cap, wherein the first pressing member presses the attachable pad body toward the surface when the operation cap is tightened; and
a second pressing member formed inside the cap at a portion that corresponds to the body wing, wherein the second pressing member presses the body wing toward the surface when the operation cap is tightened.

2. The attachable pad of claim 1, wherein the thickness of the attachment sheet ranges from 0.15 mm to 0.3 mm.

3. The attachable pad of claim 1, wherein the body wing is molded from a same material as that of the attachable pad body, and the second diameter ranges from 1.2 to 2 times the first diameter.

4. The attachable pad of claim 1, wherein the second thickness ranges from 0.3 mm to 1 mm.

5. The attachable pad of claim 1, wherein the body wing is bonded on the attachment sheet by high-frequency thermal bonding.

6. The attachable pad of claim 1, wherein the attachable pad body has a fixing screw nut, which is integrally molded inside the attachable pad body, wherein the fixing screw bolt is detachably attached to the fixing screw nut.
